(19) United States
(12) Patent Application Publication
(10) Pub. No.: US 2019/0034876 A1
(43) Pub. Date: Jan. 31, 2019

(54) ITEM REGISTRY SYSTEM

(71) Applicant: Kornic Automation Co., Ltd, Hwaseong-si (KR)

(72) Inventor: Shin Hwan HWANG, Seoul (KR)

(73) Assignee: Kornic Automation Co., Ltd

(21) Appl. No.: 16/045,777

(22) Filed: Jul. 26, 2018

(30) Foreign Application Priority Data
Jul. 31, 2017 (KR) 10-2017-0097052

(51) Int. Cl. G06Q 10/08; G06K 7/10; G06F 17/30

(52) U.S. Cl. CPC G06Q 10/0875; G06F 17/30345; G06K 7/10415

(57) ABSTRACT

Technologies related to an item registry system are provided. The item registry system includes a management server including a database configured to store item information, at least one shooting unit connected to a network and installed in a target space, and a controller. The controller includes an item identification unit configured to identify an item from an input image and determine whether the identified item is registered, a position tracker configured to track a position of the identified item, and an item management unit configured to store the item information in the database of the management server, the item information including an image of the item and a final position of the item. The item registry system may register an item brought into the target space, continuously collect information regarding the registered item, and track a position of the item.

### CROSS-REFERENCE TO RELATED APPLICATION

This application claims priority to and the benefit of Korean Patent Application No. 10-2017-0097052, filed on Jul. 31, 2017, the disclosure of which is incorporated herein by reference in its entirety.

### BACKGROUND

### 1. Field of the Invention

The present invention relates to a computing device, and more particularly, to an item registry system which manages items located in a limited space by registering the items in a database.

### 2. Discussion of Related Art

There is a trend that intelligent household appliances capable of using various types of sensors and being connected to the Internet have come into widespread use. Examples of the intelligent household appliances include devices capable of sensing whether an object having a tag attached thereto is away from a storage space.

Korean Registered Patent No. 10-1624848 discloses a smart device-based bookshelf type storage box monitoring system. The system senses whether an object, which is usually stored in a storage box, is away from the storage box by using a contact sensor, an infrared sensor, or the like, and help find the object by managing a location at which the object is stored using a tag attached to the object. However, the system is inconvenient to use because a tag should be attached to an object.

### SUMMARY OF THE INVENTION

The present invention is directed to identifying an item located in a limited space and automatically registering and managing the item.

The present invention is also directed to providing a function of searching for and displaying a location of a registered item using a means for tracking and displaying the location of the registered item.

The present invention is also directed to collecting each user's item usage behaviors and generating and providing the collected item usage behaviors in the form of customer relationship management (CRM) data.

The present invention is also directed to calculating and managing a time period elapsed after registration of the item, and displaying a warning.

According to an aspect of the present invention, an item registry system includes a management server, at least one shooting unit, and a controller. The management server includes a database configured to store item information. The at least one shooting unit is connected to a network and installed. The controller includes an item identification unit, a position tracker, and an item management unit, and manages an item by identifying the item and tracking a position of the item.

In one embodiment, the item management unit may register a non-registered item by storing item information including an image and a final position of the non-registered item.

Furthermore, the item management unit may accumulate item information regarding a registered item by storing a captured image of the registered item whenever the item is used.

The item management unit may update a final position of the registered item tracked by the position tracker.

In another embodiment, the item identification unit may identify the item by limiting items which are to be compared with the item when the item is identified to registered items near the item.

In another embodiment, the item identification unit may identify the item by receiving multi-view images from a plurality of shooting units, and the item management unit may accumulate the item information by storing the multi-view images of the item.

In another embodiment, the controller may further include a user identification unit and a user management unit. The user identification unit may identify a user and the user's position. The user management unit may store user information, including a user image, in the database of the management server and accumulate the user information by continuously storing captured images of the user.

In another embodiment, the controller may further include a usage behavior identification unit. The usage behavior identification unit may determine whether an item usage behavior of the identified user corresponds to a set item usage behavior. In this case, the item management unit may generate and store item usage behavior information about a usage behavior determined to correspond to the set item usage behavior, the behavior information including user information and a usage time.

In another embodiment, the item registry system may further include an environment sensor unit. The environment sensor unit may sense environmental information including temperature and humidity. In this case, the item management unit may store and manage the item usage behavior information by including the environmental information in the item usage behavior information.

In another embodiment, the item registry system may further include a user terminal and a pointer. The controller may further include a position indicator. The user terminal may be connected to the network and may be used to search for an item. The pointer may be configured to point out a position of the item. The position indicator may control the pointer to point out a position of an item searched for by the user terminal.

In another embodiment, the position indicator may point out the position of the item by selecting a pointer for pointing out the position of the item from among a plurality of pointers by reflecting the identified user's position.

In another embodiment, the item registry system may further include a projection unit. The controller may further include an item information provider. The projection unit provides additional information regarding the item by projecting the additional information. The item information provider may control the projection unit to provide additional information regarding the identified item.

In another embodiment, the controller may further include an operation interface unit. The operation interface unit may analyze a user's operation, determine whether the user's operation corresponds to a control command, and perform a function corresponding to the control command according to a result of determining whether the user's operation corresponds to the control command.

In another embodiment, the item registry system may further include an audio input unit. The controller may further include a voice interface unit. The voice interface unit may analyze a user's voice input to the audio input unit, determine whether the user's voice corresponds to a control command, and perform a function corresponding to the control command according to a result of determining whether the user's voice corresponds to the control command.

In another embodiment, the user terminal may display a list of items registered in the target space.

In another embodiment, the controller may further include an elapsed-time management unit. The elapsed-time management unit may calculate a time elapsed after registration of the identified item and display a warning when the elapsed time exceeds a set time.

In another embodiment, the elapsed-time management unit may manage the elapsed time by reflecting a usage period of the identified item on which the usage period is printed.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram illustrating a structure of an item registry system according to an embodiment;

FIG. 2 is a block diagram illustrating a functional structure of an item registry system according to an embodiment; and

FIG. 3 is a conceptual diagram illustrating an example in which an item is searched for by an item registry system which is set as a target space for a study, according to an embodiment.

### DETAILED DESCRIPTION OF EXEMPLARY EMBODIMENTS

The above-described aspects and additional aspects will be clearly understood from embodiments to be described below with reference to the accompanying drawings. It should be understood that components of each of the embodiments may be implemented in various combinations unless mentioned otherwise or when there is no contradiction between the components. Each block of a block diagram may represent physical components in some cases but may logically represent part of functions of one physical component or functions of a plurality of physical components in some cases. In some cases, a block or part thereof may be understood as a set of program instructions. All or some of such blocks may be implemented by hardware, software, or a combination thereof.

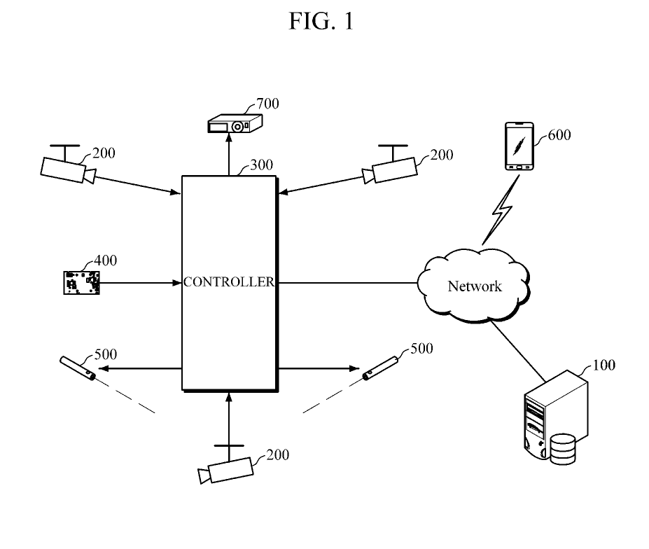

FIG. 1 is a conceptual diagram illustrating a structure of an item registry system according to an embodiment.

In one embodiment, the item registry system includes a management server 100, at least one shooting unit 200, and a controller 300, and identifies an item, manages the item by tracking a position thereof, and registers the item.

The management server 100 includes a database storing item information. Specifications of the management server 100 may be determined according to a size of a target space, the number of items to be managed, etc. The management server 100 may be a personal computer installed in a house or may consist of a plurality of physical servers installed in a data center when a plurality of target spaces are managed with respect to a plurality of users. The management server 100 is connected to a network and thus is accessible via the network. The management server 100 may be accessible via a local network when the management server 100 is installed in the target space and be accessible via the Internet when the management server 100 is installed in an external space, e.g., a service provider region.

The shooting unit 200 may be connected to the network and installed in the target space. The shooting unit 200 may be an Internet protocol (IP) camera which includes a lens, an image sensor, a processor, a memory, and a wireless/wired network interface. When the shooting unit 200 is connected to the network via wires, the shooting unit 200 may support power of Ethernet (PoE) and switching equipment connected thereto may also support the PoE. The IP camera and the PoE are well-known technologies and thus a detailed description thereof is omitted herein.

The number of shooting units 200 to be installed may be empirically determined in consideration of the size of the target space and elements, including blind spots, of the target space.

The controller 300 may be a controller, a personal computer, or a server which includes a processor and a memory in terms of hardware. Thus, the controller 300 may be included in an IP camera, an independent computer, or a separate server according to the size of the target space, the number of items to be managed, etc. Alternatively, the controller 300 may be included in the management server 100. The controller 300 may be connected to the network via a network interface of the IP camera when the controller 300 is included in an IP camera and may be connected to the network via a wired or wireless network interface of an independent computer or a separate server when the controller 300 is included in the independent computer, the separate server, or the management server 100.

According to an additional embodiment, the item registry system may include the management server 100, the at least one shooting unit 200, and the controller 300, and may further include an environment sensor unit 400. The environment sensor unit 400 may be installed in the target space, in which the item registry system is installed, to sense environmental information including temperature and humidity.

The environment sensor unit 400 may be in the form of a module obtained by separately manufacturing a temperature sensor and a humidity sensor or may be in the form of either a one-chip sensor manufactured by integrating the temperature sensor and the humidity sensor in a one-chip or two-chip composite sensor manufactured by packaging the temperature sensor and the humidity sensor. In another embodiment, the environment sensor unit 400 may be an Internet-of-Things (IoT) sensor capable of processing sensing data and transmitting the sensing data to the controller 300 via the network.

In an additional embodiment, the item registry system may include the management server 100, the at least one shooting unit 200, and the controller 300, and may further include a user terminal 600 and at least one pointer 500.

The user terminal 600 may be connected to the network to be connected to the management server 100. Examples of the user terminal 600 may include a smartphone, a tablet computer, a notebook computer, etc. In another embodiment, the user terminal 600 may be used to check a list of registered items.

The pointer 500 is a device configured to point out a location of an item to be searched for. A laser pointer may be used as the pointer 500. The laser pointer emits laser beams to point out a specific target. The laser pointer is well-known technology and thus is not described in detail herein.

The number of pointers 500 installed may be empirically determined in consideration of the size of the target space and elements, including the blind spots of the target space.

In an additional embodiment, the item registry system may include the management server 100, the at least one shooting unit 200, and the controller 300, and may further include a projection unit 700. The projection unit 700 may be installed in the target space to project an image. In this case, the image is additional information regarding an item. The projection unit 700 may be a pico projector which is a small-sized beam projector.

In an additional embodiment, the item registry system may include the management server 100, the at least one shooting unit 200, and the controller 300, and may further include an audio input unit 800. The audio input unit 800 may receive a user's voice via a microphone installed in the target space and transmit the user's voice to the controller 300. The microphone is well-known technology and thus is not described in detail herein.

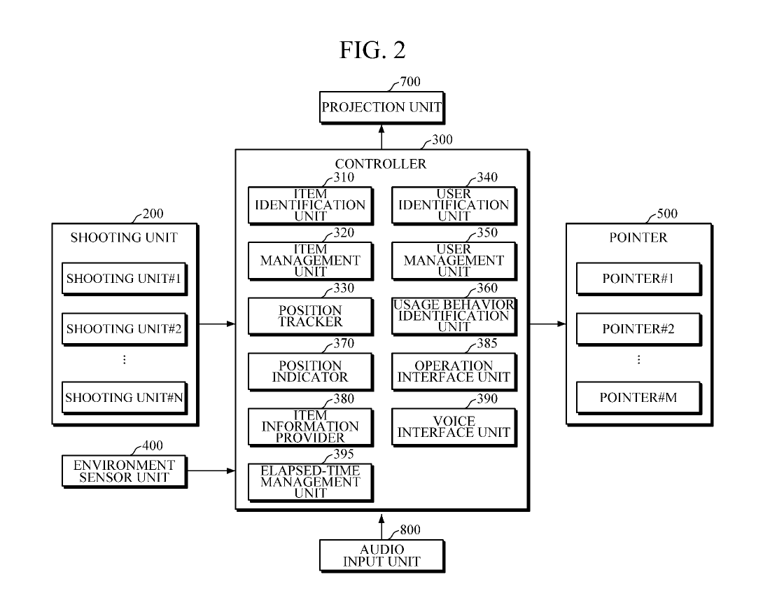

FIG. 2 is a block diagram illustrating a functional structure of an item registry system according to an embodiment.

In one embodiment, the item registry system includes a management server 100, at least one shooting unit 200, and a controller 300. In this case, the controller 300 includes an item identification unit 310, a position tracker 330, and an item management unit 320.

The controller 300 may be understood as a set of various functional blocks each consisting of a set of program instructions in terms of software. The controller 300 is connected to a network and connected to the shooting unit 200, the management server 100, etc. via the network.

The item identification unit 310 may be included in the controller 300 and may identify an item included in an input image and determine whether the item is registered. The item identification unit 310 may include a set of program instructions. The item identification unit 310 specifies and identifies an item included in an image input from the shooting unit 200 and compares the identified item with already registered items to determine whether the identified item is registered. In another embodiment of the present invention, the item identification unit 310 may limit the already registered items which are to be compared with the identified item to items neighboring to the identified item.

The position tracker 330 may be included in the controller 300 and track a position of the identified item. The position tracker 330 may include a set of program instructions. The position tracker 330 analyzes an image input from the shooting unit 200, continuously tracks a position of an item which is identified and is being used by a user, and finally stores a location at which the item is positioned. The item management unit 320 may be included in the controller 300 and store item information including a captured item image and information of a final position of the item in a database of the management server 100. The item management unit 320 may include a set of program instructions. The item management unit 320 stores, in the database, item information including item images continuously captured and collected by the shooting unit 200 and a final position of the item tracked by the position tracker 330.

In one embodiment, the item management unit 320 registers a non-registered item by storing item information including an item image and a final position of the item.

The item identification unit 310 analyzes an image input from the shooting unit 200, specifies an item, identifies the specified item, and compares the identified item with already registered items to determine whether the identified item is registered. When an item identical to the identified item is not searched for among the already registered items, the identified item is determined to be a non-registered item. The position tracker 330 tracks and manages the position of the identified item. The identified item is registered in the management server 100 by storing item information including item images collected up to a present time and the tracked position of the identified item in the database.

A non-registered item may be specified, even when cannot be exactly specified using a first captured image, by registering the item by storing captured images and a position thereof and accumulating more exact information whenever the item is used at later times.

In one embodiment, the item management unit 320 accumulates item information of a registered item by storing a captured image thereof whenever the item is used.

The item identification unit 310 specifies an item by analyzing an image input from the shooting unit 200. The item identification unit 310 identifies the specified item. The item identification unit 310 compares the identified item with already registered items to determine whether the identified item is registered. When an item identical to the identified item is searched for among the already registered items, the identified item may be determined to be a registered item, and item image information may be accumulated by continuously capturing images thereof to more exactly identify the item.

Various item images may be obtained by continuously capturing images of even an already registered item to increase a degree of identification of the item. Images and the name, trademark, model, etc. of the item may be identified and managed as item information according to the degree of identification of the item.

A captured item image may be a clear image of the item captured at a short distance or a blurred image of the item captured at a long distance according to the distance between the item and the shooting unit 200.

The item information may be divided into regions identifying features of the item to identify the item, and accumulated in the form of a tree hierarchically organized from a low level to a high level according to the degree of identification.

The features of the item may be hierarchically organized and accumulated from a low-definition image to a high-definition image. Alternatively, the features of the item may be hierarchically organized and accumulated from rough information including an outline, tone, etc. of the item to detailed information including a detailed image, color, pattern, etc. of each portion of the item. Alternatively, the features of the item may be hierarchically organized and accumulated from a level of identification of an arrangement of characters to a level of identification of the contents of the characters.

The features of the item may be used for the item identification unit 310 to search the already registered items for an item to identify the item so that the item may be hierarchically searched for according to a currently captured item image. For example, when only characters printed on the item are identified, the item may be identified by searching for the item by increasing or decreasing a level of the features of the characters according to a level of the currently captured image.

In one embodiment, the position tracker 330 updates a final position of a registered item by tracking a position of the item whenever the item is used. For example, the position tracker 330 may identify the position of the item by dividing the target space into sub-sections, allocating identification values to the sub-sections, and using, as location information, the identification value of a sub-section in which the item is positioned, or may identify the position of the item by calculating the distance, angle, etc. between the item and the shooting unit 200. However, embodiments are not limited thereto.

In another embodiment, the item identification unit 310 may identify the item by limiting items which are to be compared with the item to registered items neighboring to the item. An item image captured to identify the item which a user uses may be compared with already registered items. In this case, when the items to be compared with the item are limited to registered items neighboring to the item, the item may be efficiently identified.

Even if items to be compared with the item are limited to registered items neighboring to the item, when an item identical to the item used is not searched for, the item may not be directly registered and may be compared with all registered items, thereby preventing duplicate registration of the item.

In another embodiment, the item identification unit 310 may identify an item by receiving multi-view images from a plurality of shooting units 200 installed in the target space, and the item management unit 320 may accumulate item information by storing the multi-view images.

Blind spots of the target space may be removed using the plurality of shooting units 200. Accordingly, the item may be identified and a position thereof may be tracked regardless of a position of the item in the target space.

The number of shooting units 200 installed may be empirically determined in consideration of a size of the target space and elements, including the blind spots of the target space.

More accurate information regarding the item image may be collected by capturing multi-view item images by the plurality of shooting units 200 and storing the multi-view item images, and thus, a degree of identification of the item may be improved. Since item images are captured at various angles, information regarding a three-dimensional (3D) shape of the item may be obtained. Furthermore, information regarding various partial images of the item may be accumulated.

In an additional embodiment, the item registry system may include the management server 100, the at least one shooting unit 200, and the controller 300. In this case, the controller 300 may include the item identification unit 310, the position tracker 330, and the item management unit 320, and may further include a user identification unit 340 and a user management unit 350.

The user identification unit 340 may be included in the controller 300 and identify a user and the user's position. The user identification unit 340 may include a set of program instructions. The user identification unit 340 may specify and identify the user in an image input from the shooting unit 200.

The user identification unit 340 may also identify the user's position. For example, the user identification unit 340 may identify the user's position by dividing the target space into sub-sections, allocating identification values to the sub-sections, and using, as location information, the identification value of a sub-section in which the user is positioned, or may identify the user's position by calculating the distances, angles, etc. between the user and the shooting units 200. However, embodiments are not limited thereto.

In this case, the identified user may be a human being or a pet that continuously uses the target space.

The user management unit 350 may be included in the controller 300 and store user information, including a user image, in the database of the management server 100. Furthermore, the user management unit 350 may accumulate the user information by storing continuously captured user images. The user management unit 350 may include a set of program instructions.

The user management unit 350 may store and manage user information of a human being or a pet that continuously uses the target space. Information, e.g., sex, age, etc., regarding the user may be identified by continuously accumulating images of the user.

In another embodiment, the user identification unit 340 of the item registry system specifies the user by analyzing an image input from the shooting unit 200. The user identification unit 340 identifies the specified user. Furthermore, the user identification unit 340 may identify the identified user's position. The user management unit 350 collects image by continuously capturing user images. The user management unit 350 stores user information including the captured user images in the database of the management server 100.

In an additional embodiment, the item registry system may include the management server 100, the at least one shooting unit 200, and the controller 300. In this case, the controller 300 may include the item identification unit 310, the position tracker 330, the item management unit 320, the user identification unit 340, and the user management unit 350, and may further include a usage behavior identification unit 360.

The usage behavior identification unit 360 may be included in the controller 300, and determine whether an item usage behavior of the identified user is same as a set item usage behavior. The usage behavior identification unit 360 may include a set of program instructions.

The set item usage behavior is an expected behavior of using a specific item and may be previously determined or set according to a type of the item. For example, when the identified item is a household vacuum cleaner, cleaning the target space using the household vacuum cleaner may be a predetermined usage behavior or may be the set item usage behavior.

The usage behavior identification unit 360 determines whether a user's behavior of using an item for which an item usage behavior is set corresponds to the set item usage behavior, and collects information regarding the user and when, how long, and where the item was used, when the user's behavior corresponds to the set usage behavior.

The item management unit 320 may generate and store item usage behavior information including user information and usage time information with respect to a usage behavior determined to correspond to the set item usage behavior. Item usage behavior information collected by the usage behavior identification unit 360 is stored with respect to an item corresponding thereto. The stored information may be accumulated in the form of customer relationship management (CRM) data, and may be provided, if necessary.

In another embodiment, the item identification unit 310 specifies an item by analyzing an image input from the shooting unit 200. The item identification unit 310 identifies the specified item. The item identification unit 310 compares the identified item with already registered items, and determines that the identified item is a registered item when an item identical to the items is searched for among the already registered items.

The user identification unit 340 specifies a user by analyzing an image input from the shooting unit 200. The user identification unit 340 identifies the specified user. Furthermore, the user identification unit 340 identifies the identified user's position.

The usage behavior identification unit 360 identifies an item usage behavior of the identified user. The usage behavior identification unit 360 determines whether the item usage behavior of the identified user corresponds to the set item usage behavior, and collects information regarding the user and when, how long, and where the item was used, when the item usage behavior of the identified user corresponds to the set item usage behavior.

The item management unit 320 stores item usage behavior information, including user information and usage time information related to an item usage behavior, with respect to the item corresponding thereto in the database of the management server 100.

In an additional embodiment, the item registry system may include the management server 100, the at least one shooting unit 200, and the controller 300, and may further include an environment sensor unit 400. In this case, the controller 300 may include the item identification unit 310, the position tracker 330, the item management unit 320, the user identification unit 340, the user management unit 350, and the usage behavior identification unit 360.

The item management unit 320 may store and manage environmental information collected by the environment sensor unit 400 by including the environmental information in the item usage behavior information. The item management unit 320 may generate and accumulate CRM data regarding usage of the item, including the environmental information.

In an additional embodiment, the item registry system may include the management server 100, the at least one shooting unit 200, and the controller 300, and may further include a user terminal 600 and a pointer 500. In this case, the controller 300 may include the item identification unit 310, the position tracker 330, and the item management unit 320, and may further include a position indicator 370.

The user terminal 600 may be connected to a network to be connected to the management server 100 and search for a position of an item.

The number of pointers 500 installed may be empirically determined in consideration of the size of the target space and elements, including the blind spots of the target space.

The position indicator 370 may be included in the controller 300 and control the pointer 500 to point out the position of the item. The position indicator 370 may include a set of program instructions.

In this case, a position pointed out by the pointer 500 is a final position of the item which is tracked by the position tracker 330 and stored. Thus, when a user searches for an item using the user terminal 600, the final position of the item stored in the database of the management server 100 may be identified and the pointer 500 is controlled to point out the position of the item by the position indicator 370.

In another embodiment, a user accesses the management server 100 via the user terminal 600. The management server 100 provides the user terminal 600 with a user interface (UI) to search for an item. The user may search for a desired item using the UI. When searching for the desired item succeeds, the position indicator 370 controls the pointer 500 to point out a position of the item using laser beams.

In another additional embodiment, the controller 300 may further include the user identification unit 340. The user identification unit 340 identifies a position of a user who searches for an item.

In this case, the position indicator 370 may point out a position of an item by selecting a pointer 500 to be used to point out the position of the item from among a plurality of pointers 500 by reflecting the identified user's position. That is, the user who identifies the position of the item may be identified, the user's position may be identified, a pointer 500 appropriate to point out the position of the item at the user's position may be selected from among the plurality of pointers 500, and the position of the item may be pointed out by the selected pointer 500 using laser beams.

In an additional embodiment, the item registry system may include the management server 100, the at least one shooting unit 200, and the controller 300, and may further include a projection unit 700. In this case, the controller 300 may include the item identification unit 310, the position tracker 330, and the item management unit 320, and may further include an item information provider 380.

The item information provider 380 may control the projection unit 700 to provide additional information of the identified item by projecting an image. The item information provider 380 may include a set of program instructions. In another embodiment, the provided additional information may include information, such as a registration date of the item, user information, time when the item was used by each user, the position of the item, etc.

In an additional embodiment, the item registry system may include the management server 100, the at least one shooting unit 200, and the controller 300. In this case, the controller 300 may include the item identification unit 310, the position tracker 330, and the item management unit 320, and may further include an operation interface unit 385.

The operation interface unit 385 may be included in the controller 300, analyze a user's operation to determine whether the user's operation corresponds to a control command, and perform a function corresponding to the control command according to a result of analyzing the user's operation. The operation interface unit 385 may include a set of program instructions.

When a user makes a predetermined gesture, the operation interface unit 385 may identify the gesture, determine whether the identified gesture corresponds to a predetermined interface operation, and perform a control command corresponding to the predetermined interface operation when the identified gesture corresponds to the predetermined interface operation, thereby providing a function corresponding to the predetermined interface operation. For example, in another embodiment, a command instructing to increase or decrease a size of an additional information screen provided by identifying a finger's operation may be executed. In an additional embodiment, a voice output unit may be further provided to output information regarding an item, which is pointed out by a user's finger, in the form of voice.

Some gestures corresponding to control commands may be set during installation of the system or may be added by a user during use of the system.

In another embodiment, the operation interface unit 385 identifies an operation by analyzing a user's operation from an image input from the shooting unit 200. The operation interface unit 385 determines whether the identified operation corresponds to a predetermined interface operation, i.e., a control command. When the identified operation is determined to correspond to the predetermined interface operation, a function corresponding to the control command is performed.

In an additional embodiment, the item registry system may include the management server 100, the at least one shooting unit 200, and the controller 300, and may further include an audio input unit 800. In this case, the controller 300 may include the item identification unit 310, the position tracker 330, and the item management unit 320, and may further include a voice interface unit 390.

The audio input unit 800 receives a user's voice and transmits it to the controller 300.

The voice interface unit 390 may analyze the user's voice input via the audio input unit 800 to determine whether the user's voice corresponds to a control command and perform a predetermined function corresponding to a result of analyzing the user's voice.

When a user says a predetermined command, the voice interface unit 390 may identify the user's voice, determine whether the identified voice corresponds to the predetermined command, and perform a control command matching the predetermined command to provide a corresponding function when the identified voice corresponds to the predetermined command. For example, in another embodiment, when the user says ‘additional information’ during use of an item, additional information of the item may be projected via the projection unit 700. In an additional embodiment, a voice output unit (not shown) may be further provided, and thus, when the user says a voice command instructing to provide information regarding an item which is being used, the information regarding the item may be output to the voice output unit while this information is projected via the projection unit 700.

Some voice commands corresponding to control commands may be set during the manufacture of a multimedia device or may be added by a user during use of an item.

In another embodiment, the voice interface unit 390 identifies a user's voice by analyzing an audio signal input from the audio input unit 800. The voice interface unit 390 determines whether the identified user's voice corresponds to a predetermined control command. When the identified user's voice is determined to correspond to the predetermined control command, a function corresponding to the control command is performed.

In an additional embodiment, the item registry system may include the management server 100, the at least one shooting unit 200, and the controller 300, and may further include the user terminal 600. In this case, the user terminal 600 may display a list of items registered in the target space so that the registered items may be viewed.

In an additional embodiment, the item registry system may include the management server 100, the at least one shooting unit 200, the user terminal 600, and the controller 300. In this case, the controller 300 may include the item identification unit 310, the position tracker 330, and the item management unit 320, and may further include an elapsed-time management unit 395.

The elapsed-time management unit 395 may calculate a time elapsed after registration of an identified item and display a warning when the elapsed time exceeds a set time. The elapsed-time management unit 395 may include a set of program control commands.

The set time may be empirically set to display the warning according to the type of the target space. Alternatively, the set time may be set differently according to the type of the identified item. For example, when the target space is a refrigerator, the set time may be set to maintain the freshness of food which is the identified item.

When the time elapsed after the registration of the identified item exceeds the set time, the warning may be displayed on the user terminal 600. In another embodiment, the elapsed time may be displayed when a list of registered items is displayed on the user terminal 600. In another embodiment, a warning message may be projected via the projection unit 700 when use of an item exceeds the set time

In another embodiment, the item identification unit 310 specifies an item which is in use by a user by analyzing an image input from the shooting unit 200. The item identification unit 310 identifies the specified item. The identified item is compared with already registered items to determine whether the identified item is registered. When an item identical to the identified item is not searched from among the registered items, the identified item is determined to be a non-registered item. In the case of the non-registered item, the elapsed-time management unit 395 stores information regarding time when this item was brought into the target space. In this case, a time elapsed from the time when the item was brought into the target space is calculated. The elapsed-time management unit 395 periodically calculates elapsed times of the registered items. A time interval at which an elapsed time is calculated may be, for example, a unit of day or a unit of hour and may be empirically set by a user. The elapsed-time management unit 395 calculates elapsed times of the items and displays a warning with respect to items exceeding the set time.

In another embodiment, the elapsed-time management unit 395 may identify a usage period of an item on which the usage period is printed and manage an elapsed time of the item by reflecting the usage period into the elapsed time. When the item identification unit 310 identifies the usage period of the item, on which the usage period is printed, whether the elapsed time exceeds the set time may be determined in consideration of the identified usage period, and the warning may be displayed.

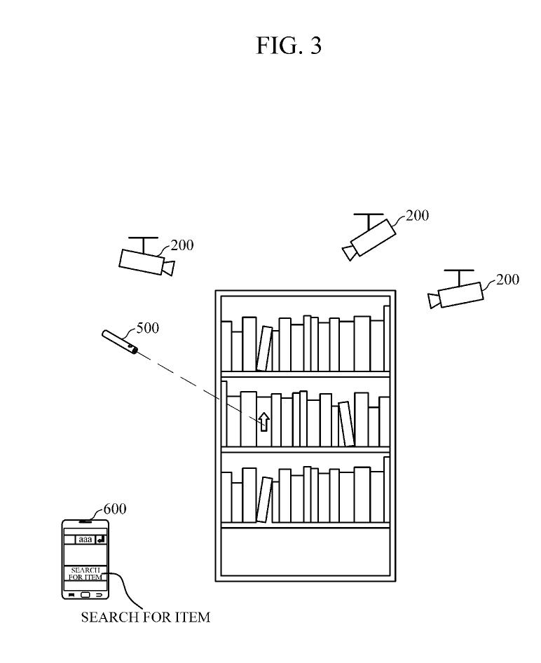

FIG. 3 is a conceptual diagram illustrating an example in which an item is searched for by an item registry system which is set for a study as a target space, according to an embodiment.

As illustrated in FIG. 3, items registered in an item registry system which is set for a study as a target space may be books stocked in a bookshelf. FIG. 3 illustrates an example in which a user inputs the title of a desired book among registered books through a search UI provided via the management server 100 using a user terminal 600, and the position indicator 370 controls the pointer 500 to point out a position of the desired book using laser beams.

In another embodiment, when a shop is set as a target space, products brought to the shop may be registered and managed by tracking positions of the products. Furthermore, detailed product information, including costs, manufacturer names, warehousing dates, expiration dates, etc., may be identified from continuously captured images, accumulated, and used. As described above, a target space for the item registry system is not limited and the item registry system may be used in various spaces such as offices, schools, shops, living rooms, bedrooms, kitchens, and warehouses.

According to the present invention set forth herein, an item can be automatically registered and a position thereof can be displayed by searching registered items for the item.

According to the present invention, a position of an item can be tracked and managed whenever the item is used.

According to the present invention, users' item usage behaviors can be collected and a result of the collection can be generated and provided in the form of CRM data.

Furthermore, according to the present invention, a time elapsed after registration of an item can be calculated and managed, and a warning can be displayed so that the item may be used within a usage period thereof.

While embodiments of the present invention have been described above with reference to the accompanying drawings, the present invention is not limited thereto and should be construed as covering various modified examples derivable from the embodiments by those of ordinary skill in the art. The appended claims are intended to cover such modified examples.

What is claimed is:

1. An item registry system comprising:
a management server including a database configured to store item information;
at least one shooting unit connected to a network and installed in a target space; and
a controller comprising:
an item identification unit configured to identify an item from an input image and determine whether the identified item is registered;
a position tracker configured to track a position of the identified item; and
an item management unit configured to store the item information in the database of the management server, the item information including an image and a final position of the item.

2. The item registry system of claim 1, wherein the item management unit registers a non-registered item by storing item information including an image and a final position of the non-registered item.

3. The item registry system of claim 1, wherein the item management unit accumulates item information of a registered item by storing a captured image of the registered item whenever the item is used.

4. The item registry system of claim 3, wherein the position tracker tracks a position of the registered item and updates a final position thereof whenever the item is used.

5. The item registry system of claim 3, wherein the item identification unit identifies the item by limiting items which are to be compared with the item when the item is identified to registered items neighboring to the item.

6. The item registry system of claim 1, wherein the item identification unit identifies the item by receiving multi-view images from a plurality of shooting units installed in the target space, and
the item management unit accumulates the item information by storing the multi-view images of the item.

7. The item registry system of claim 1, wherein the controller further comprises:
a user identification unit configured to identify a user and the user's position; and
a user management unit configured to store user information in the database of the management server, the user information including an image of the user,
wherein the user management unit accumulates the user information by continuously storing captured images of the user.

8. The item registry system of claim 7, wherein the controller further comprises a usage behavior identification unit configured to determine whether an item usage behavior of the identified user corresponds to a set item usage behavior, and
the item management unit generates and stores item usage behavior information about a usage behavior determined to correspond to the set item usage behavior, the behavior information including user information and a usage time.

9. The item registry system of claim 8, further comprising an environment sensor unit configured to sense environmental information including temperature and humidity, the environment sensor being installed in the target space, and
wherein the item management unit stores and manages the item usage behavior information by including the environmental information in the item usage behavior information.

10. The item registry system of claim 1, further comprising:
a user terminal connected to the network; and
at least one pointer installed in the target space, and
wherein the controller further comprises a position indicator configured to control the at least one pointer to point out the position of the item, and
when an item is searched for using the user terminal, the position indicator points out a position of the searched for item.

11. The item registry system of claim 10, wherein the controller further comprises a user identification unit configured to identify a user and the user's position, and
the position indicator points out the position of the item by selecting a pointer for point outing the position of the item from among a plurality of pointers by reflecting the identified user's position.

12. The item registry system of claim 1, further comprising a projection unit installed in the target space, and
wherein the controller further comprises an item information provider configured to control the projection unit to provide additional information regarding the identified item.

13. The item registry system of claim 1, wherein the controller further comprises an operation interface unit configured to analyze a user's operation, determine whether the user's operation corresponds to a control command, and perform a function corresponding to the control command according to a result of determining whether the user's operation corresponds to the control command.

14. The item registry system of claim 1, further comprising an audio input unit installed in the target space, and
wherein the controller further comprises a voice interface unit configured to analyze a user's voice, determine whether the user's voice corresponds to a control command, and perform a function corresponding to the control command according to a result of determining whether the user's voice corresponds to the control command.

15. The item registry system of claim 1, further comprising a user terminal connected to the network,
wherein the user terminal displays a list of items registered in the target space.

16. The item registry system of claim 15, wherein the controller further comprises an elapsed-time management unit configured to calculate a time elapsed after registration of the identified item and display a warning when the elapsed time exceeds a set time.

17. The item registry system of claim 16, wherein the elapsed-time management unit manages the elapsed time by reflecting a usage period of the identified item on which the usage period is printed.
